(19) United States
(12) Patent Application Publication
(10) Pub. No.: US 2026/0267204 A1
(43) Pub. Date: Sep. 10, 2026

(54) ADHESIVE INJECTION STRUCTURE OF CAMERA MODULE

(71) Applicant: Luxshare Intelligent Manufacture Technology (Changshu) Co., Ltd, Changshu City (CN)

(72) Inventors: Fuyuan WU, Changshu City (CN); Shangyu HSU, Changshu City (CN); Mengting LIN, Changshu City (CN); Kaijing FU, Changshu City (CN); Shihwei Hung, Changshu City (CN); Poying TSENG, Changshu City (CN); Chenyu CHAO, Changshu City (CN)

(73) Assignee: Luxshare Intelligent Manufacture Technology (Changshu) Co., Ltd, Changshu City (CN)

(21) Appl. No.: 19/360,155

(22) Filed: Oct. 16, 2025

(30) Foreign Application Priority Data
Mar. 10, 2025 (CN) 202510276123.6

(51) Int. Cl. G03B 17/08; G03B 17/12

(52) U.S. Cl. CPC G03B 17/08; G03B 17/12

(57) ABSTRACT

Provided is an adhesive injection structure of a camera module. The adhesive injection structure includes adhesive injection channels, guide grooves, a capillary channel and adhesive overflow grooves. The adhesive injection channels are arranged at intervals along a circumferential direction of a base, among the adhesive injection channels, adhesive injection ports are located at an end of the base facing away from a magnet assembly, and adhesive outlets face an inner wall of a shielding cover. The guide grooves are connected to the adhesive outlets in one-to-one correspondence, and outlet ends of the guide grooves face the inner wall of the shielding cover. The capillary channel is disposed between the shielding cover and the base and connected to each guide groove. The adhesive overflow grooves are connected to the adhesive outlets in one-to-one correspondence, and outlet ends of the adhesive overflow grooves face the magnet assembly.

### CROSS-REFERENCE TO RELATED APPLICATIONS

This application claims priority to Chinese Patent Application No. 202510276123.6 filed Mar. 10, 2025, the disclosure of which is incorporated herein by reference in its entirety.

### TECHNICAL FIELD

The present disclosure relates to the technical field of camera devices and, in particular, to an adhesive injection structure of a camera module.

### BACKGROUND

A camera module refers to a modular product that integrates assemblies such as a lens, an image sensor, a digital signal processor, a voice coil motor (VCM), an infrared (IR) filter and a circuit board and is widely used in the fields such as mobile phones, computers, security and surveillance and smart homes, thereby bringing convenience to people's lives and work.

At present, to facilitate the mass production of the camera module, a flipping device is generally used to flip the camera module, and a dispensing device is used to perform full-perimeter sealing on the camera module. Specifically, in the related art, four groups of flipping devices and dispensing devices are used during dispensing to achieve the full-perimeter sealing of the camera module. In a dispensing process, multiple workstations are arranged, and the camera module is flipped multiple times. This makes the entire dispensing operation relatively complex and increases the steps for completing the dispensing, thereby reducing operation efficiency. Moreover, the operating space for the dispensing is relatively limited due to a relatively integrated structure of the camera module, so that the dispensing effect is difficult to ensure.

### SUMMARY

The present disclosure provides an adhesive injection structure of a camera module. The camera module includes a base, a magnet assembly fixed on the base, a movable assembly movably disposed on the base, a lens mounted on the movable assembly and a shielding cover covering the base, both the magnet assembly and the movable assembly are located in a mounting cavity of the shielding cover, and the adhesive injection structure of the camera module includes multiple adhesive injection channels, multiple guide grooves, a capillary channel and multiple adhesive overflow grooves.

The multiple adhesive injection channels are arranged at intervals along a circumferential direction of the base, adhesive injection ports of the multiple adhesive injection channels are located at an end of the base facing away from the magnet assembly, and adhesive outlets of the multiple adhesive injection channels face an inner wall of the shielding cover.

The multiple guide grooves are disposed at intervals on an outer periphery of the base and connected to the multiple adhesive outlets in one-to-one correspondence, and outlet ends of the multiple guide grooves face the inner wall of the shielding cover.

The capillary channel is disposed between the shielding cover and the base and connected to each guide groove.

The multiple adhesive overflow grooves are disposed at intervals on the outer periphery of the base and connected to the multiple adhesive outlets in one-to-one correspondence, and outlet ends of the multiple adhesive overflow grooves face the magnet assembly.

In one or more embodiments, a buffer step is disposed in an adhesive injection channel and is disposed at an angle with an extension direction of the adhesive injection channel.

In one or more embodiments, multiple buffer steps are disposed at intervals along the extension direction of the adhesive injection channel, and areas of the multiple buffer steps are decreased in sequence along a direction from an adhesive injection port of the adhesive injection channel to an adhesive outlet of the adhesive injection channel.

In one or more embodiments, an opening size of a guide groove is gradually increased from a side of the guide groove facing away from the inner wall of the shielding cover to a side of the guide groove facing the inner wall of the shielding cover.

In one or more embodiments, a diameter expanded portion is disposed in an adhesive overflow groove, and an outlet end of the adhesive overflow groove is disposed at the diameter expanded portion.

In one or more embodiments, an adhesive pouring groove is disposed on a peripheral wall of the base, an outlet end of the adhesive pouring groove faces the inner wall of the shielding cover, and the adhesive pouring groove and the inner wall of the shielding cover enclose to form an adhesive pouring channel.

In one or more embodiments, a step portion is disposed in the adhesive pouring groove and arranged at an angle with an extension direction of the adhesive pouring groove.

In one or more embodiments, a guide portion is further disposed in the adhesive pouring groove and gradually approaches the inner wall of the shielding cover in a direction toward the magnet assembly.

In one or more embodiments, multiple adhesive pouring grooves are disposed at intervals along the circumferential direction of the base.

In one or more embodiments, a first avoidance port is disposed on the base, and a second avoidance port is disposed on the shielding cover; the movable assembly includes a movable frame and a coil assembly wound around the movable frame, where a third avoidance port is disposed on the movable frame, and the magnet assembly is disposed around the coil assembly; a front end of the lens passes through the third avoidance port and the second avoidance port in sequence, and a rear end of the lens is exposed from the first avoidance port.

### BRIEF DESCRIPTION OF DRAWINGS

FIG. 1 is a first axonometric view of a camera module according to an embodiment of the present disclosure.

FIG. 2 is a second axonometric view of a camera module according to an embodiment of the present disclosure.

FIG. 3 is a top view of a camera module according to an embodiment of the present disclosure.

FIG. 4 is an exploded view of a camera module according to an embodiment of the present disclosure.

FIG. 5 is a cross-sectional view of a camera module according to an embodiment of the present disclosure.

FIG. 6 is a partial enlarged view of part A of FIG. 5.

FIG. 7 is a first axonometric view of a base according to an embodiment of the present disclosure.

FIG. 8 is a partial enlarged view of part B of FIG. 7.

FIG. 9 is a second axonometric view of a base according to an embodiment of the present disclosure.

FIG. 10 is a partial enlarged view of part C of FIG. 9.

FIG. 11 is a third axonometric view of a base according to an embodiment of the present disclosure.

FIG. 12 is a partial enlarged view of part D of FIG. 11.

### DETAILED DESCRIPTION

This disclosure is further described in detail hereinafter in conjunction with drawings and embodiments. It is to be understood that the embodiments described herein are intended to explain the present disclosure and not to limit the present disclosure. Additionally, it is to be noted that for ease of description, part, not all, of the structures related to this disclosure are illustrated in the drawings.

In the description of the present disclosure, terms "joined", "connected", and "secured" are to be understood in a broad sense unless otherwise expressly specified and limited. For example, the term "connected" may refer to "securely connected", "detachably connected", or "integrated", may refer to "mechanically connected" or "electrically connected", may refer to "connected directly" or "connected indirectly through an intermediary", or may refer to "connected inside two elements" or "an interaction relation between two elements". For those of ordinary skill in the art, specific meanings of the preceding terms in the present disclosure may be understood based on specific situations.

In the present disclosure, unless otherwise expressly specified and limited, when a first feature is described as "above" or "below" a second feature, the first feature and the second feature may be in direct contact, or the first feature and the second feature may be in contact via another feature between the two features instead of being in direct contact. Moreover, when the first feature is described as being "on", "above", or "over" the second feature, the first feature is right on, above, or over the second feature, the first feature is obliquely on, above, or over the second feature, or the first feature is simply at a higher level than the second feature. When the first feature is described as being "under", "below", or "underneath" the second feature, the first feature is right under, below, or underneath the second feature, the first feature is obliquely under, below, or underneath the second feature, or the first feature is simply at a lower level than the second feature.

In the description of this embodiment, orientations or position relations indicated by terms such as "upper", "lower", and "right" are based on the drawings. These orientations or position relations are intended only to facilitate description and simplify operations and not to indicate or imply that a device or element referred to must have such particular orientations or must be configured or operated in such particular orientations. Thus, these orientations or position relations are not to be construed as limiting the present disclosure. Additionally, terms "first" and "second" are used for distinguishing between descriptions and have no special meanings.

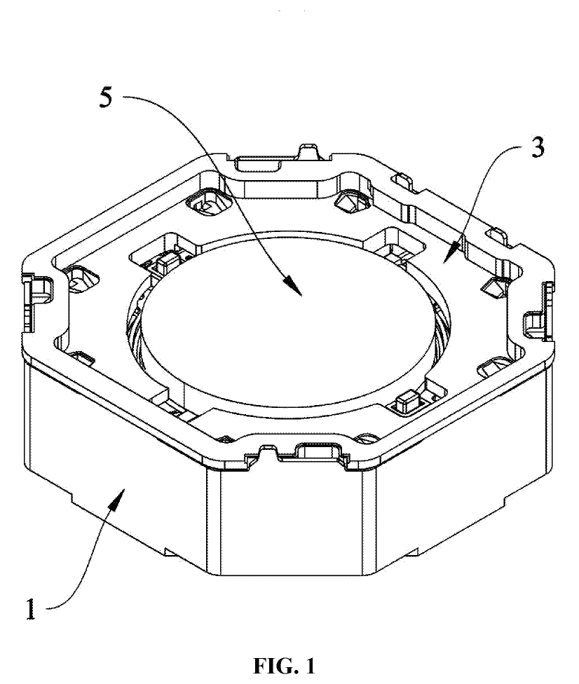

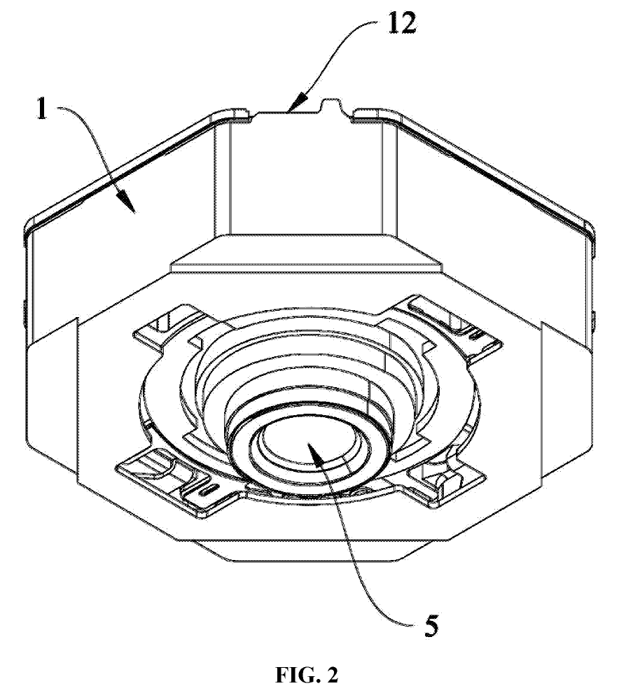

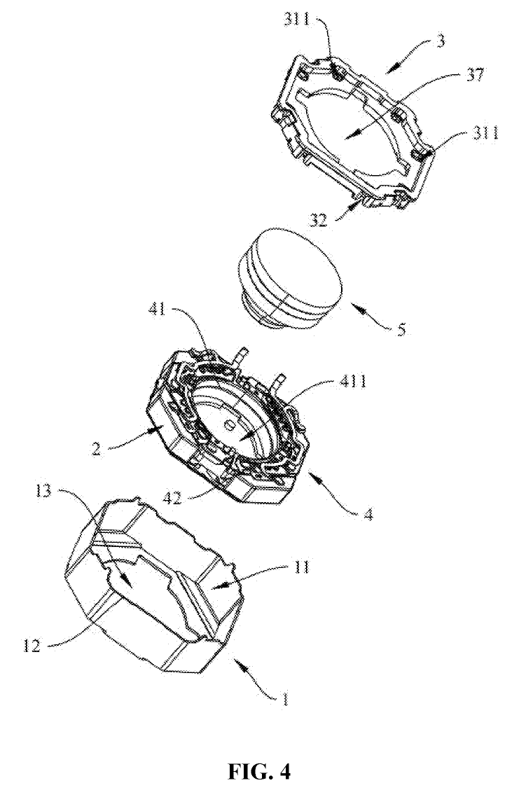

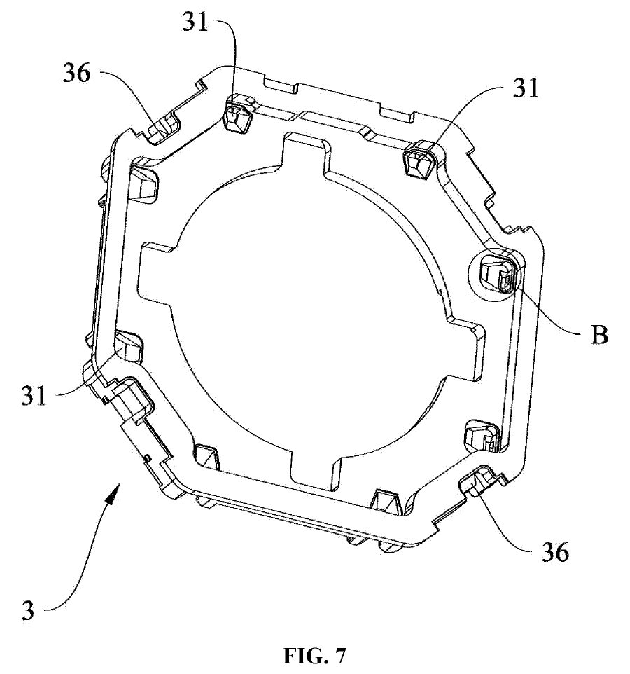

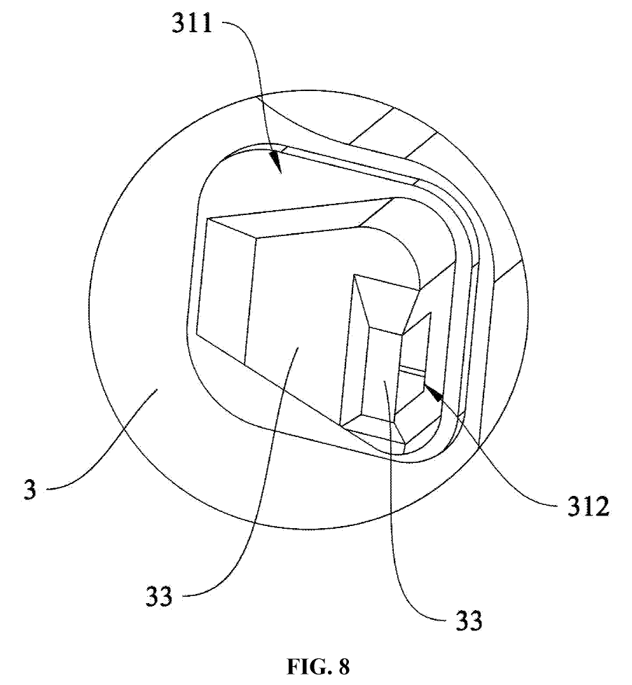

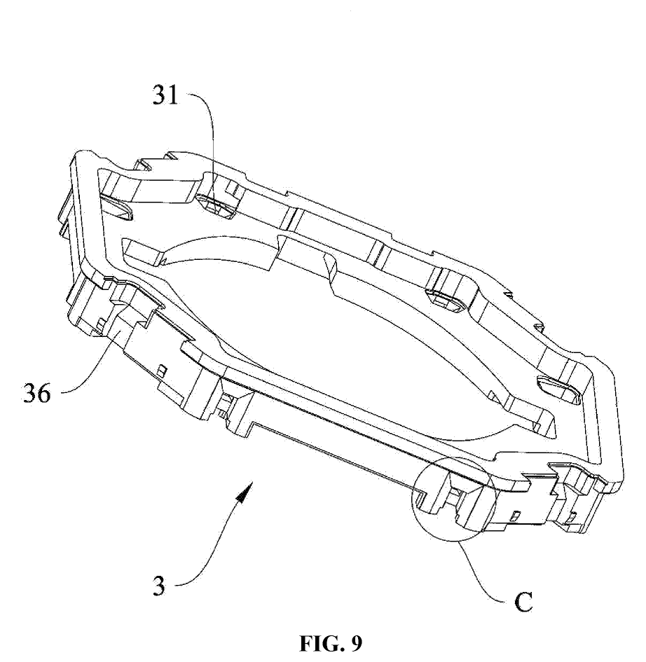

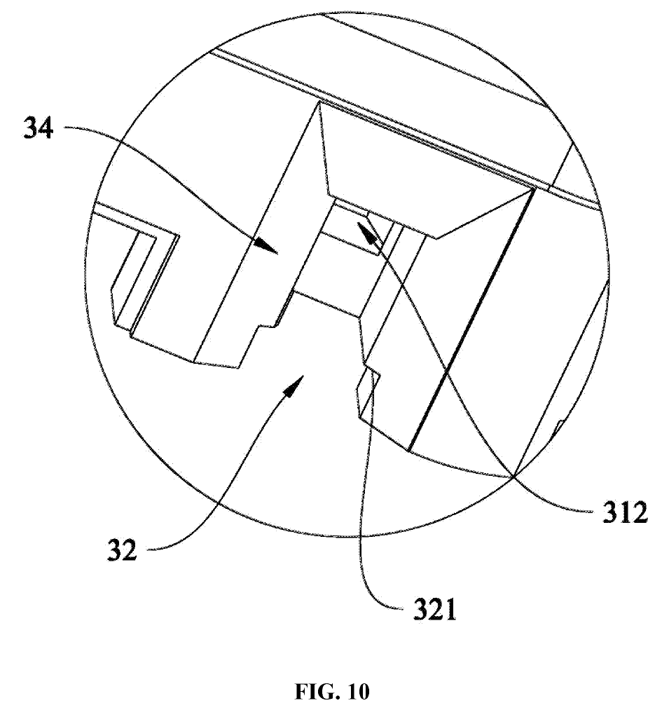

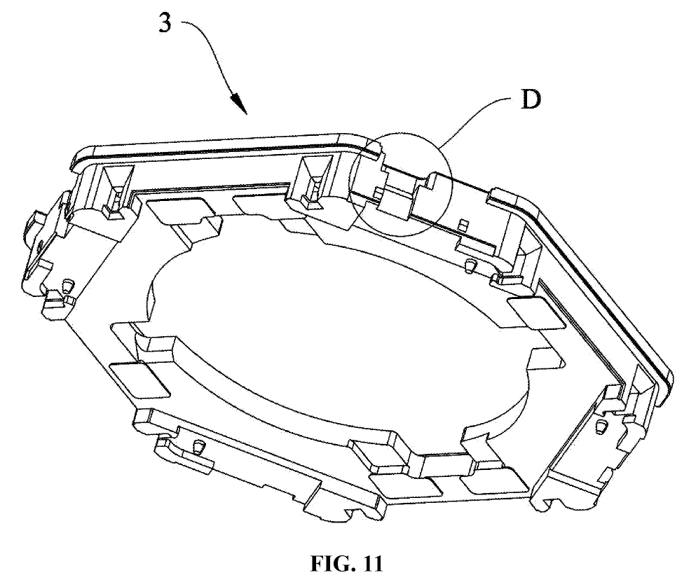

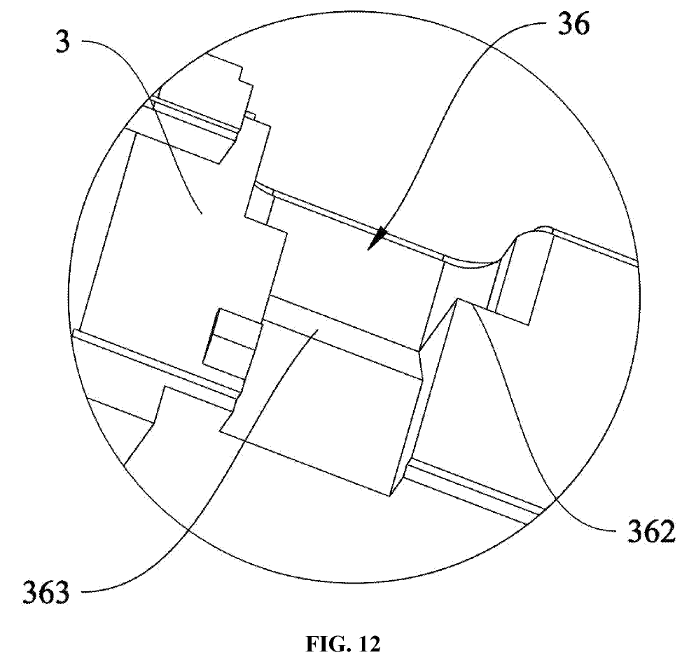

As shown in FIGS. 1 to 12, the present embodiment provides an adhesive injection structure of a camera module. The camera module includes a base 3, a magnet assembly 2 fixed on the base 3, a movable assembly 4 movably disposed on the base 3, a lens 5 mounted on the movable assembly 4 and a shielding cover 1 covering the base 3, both the magnet assembly 2 and the movable assembly 4 are located in a mounting cavity 11 of the shielding cover 1, and the adhesive injection structure of the camera module includes multiple adhesive injection channels 31, multiple guide grooves 34, a capillary channel 35 and multiple adhesive overflow grooves 32. The multiple adhesive injection channels 31 are arranged at intervals along a circumferential direction of the base 3, an adhesive injection port 311 of each adhesive injection channel 31 is located at an end of the base 3 facing away from the magnet assembly 2, and an adhesive outlet 312 of each adhesive injection channel 31 faces an inner wall of the shielding cover 1. The multiple guide grooves 34 are disposed at intervals on an outer periphery of the base 3 and connected to multiple adhesive outlets 312 in one-to-one correspondence, and outlet ends of the guide grooves 34 face the inner wall of the shielding cover 1. The capillary channel 35 is disposed between the shielding cover 1 and the base 3 and connected to each guide groove 34. The multiple adhesive overflow grooves 32 are disposed at intervals on the outer periphery of the base 3 and connected to the multiple adhesive outlets 312 in one-to-one correspondence, and outlet ends of the adhesive overflow grooves 32 face the magnet assembly 2.

In the present embodiment, the adhesive injection structure is disposed to facilitate the full-perimeter sealing of the camera module and improve the dispensing effect. The adhesive injection structure includes the adhesive injection channels 31, the guide grooves 34, the capillary channel 35 and the adhesive overflow grooves 32. Arranging the multiple adhesive injection channels 31 at intervals along the circumferential direction of the base 3 can ensure that the adhesive is uniformly distributed along the circumferential direction of the base 3, thereby ensuring a dispensing effect between the base 3 and other components and improving the overall structural strength of the camera module. The adhesive injection ports 311 of the adhesive injection channels 31 are located at the end of the base 3 facing away from the magnet assembly 2 so that no flipping operation is performed on the camera module to improve the convenience of the dispensing operation. The adhesive outlets 312 of the adhesive injection channels 31 face the inner wall of the shielding cover 1, thereby ensuring that the adhesive can reach the shielding cover 1 via the adhesive outlets 312 and improving the connection strength between the base 3 and the shielding cover 1. The multiple guide grooves 34 are disposed at intervals on the outer periphery of the base 3 and connected to the multiple adhesive outlets 312 in one-to-one correspondence, and the outlet ends of the guide grooves 34 face the inner wall of the shielding cover 1, thereby ensuring that the adhesive can fully cover the inner wall of the shielding cover 1 and improving the dispensing effect between the base 3 and the shielding cover 1. The capillary channel 35 is disposed between the shielding cover 1 and the base 3 and connected to each guide groove 34 so that the adhesive in the guide groove 34 can reach the capillary channel 35 under capillary action, thereby further improving the dispensing effect. The multiple adhesive overflow grooves 32 are disposed at intervals on the outer periphery of the base 3 and connected to the multiple adhesive outlets 312 in one-to-one correspondence, and the outlet ends of the adhesive overflow grooves 32 face the magnet assembly 2 so that the adhesive in the adhesive injection channels 31 can reach the magnet assembly 2 via the adhesive overflow grooves 32 to achieve adhesion and fixation, thereby ensuring the dispensing effect. The adhesive injection structure of the camera module in the present embodiment can facilitate the dispensing operation of the camera module, thereby improving the dispensing effect and the operation efficiency.

A specific structure of the adhesive injection structure of the camera module is described below.

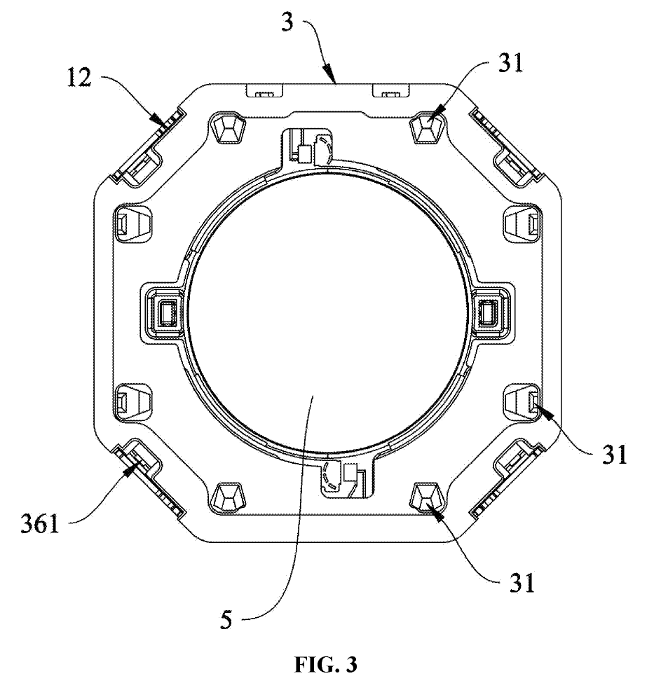

As shown in FIGS. 3 to 8, a buffer step 33 is disposed in the adhesive injection channel 31 and is arranged at an angle with an extension direction of the adhesive injection channel 31. When the adhesive flows onto the buffer step 33, the flow speed of the adhesive is slowed down so that the adhesive flows more smoothly in the adhesive injection channel 31 and is distributed more uniformly, thereby improving the dispensing effect.

Moreover, multiple buffer steps 33 are arranged at intervals along the extension direction of the adhesive injection channel 31 so that the flow speed of the adhesive can be gradually slowed down step by step, and further the uniform diffusion of the adhesive in the adhesive injection channel 31 can be increased. Areas of the multiple buffer steps 33 are decreased in sequence along a direction from the adhesive injection port 311 to the adhesive outlet 312 so that a flow path of the adhesive can be optimized to ensure that the adhesive can accurately flow toward the adhesive outlet 312, thereby improving the dispensing effect. Moreover, an inclined surface is disposed between buffer steps 33 to facilitate the flow and diffusion of the adhesive.

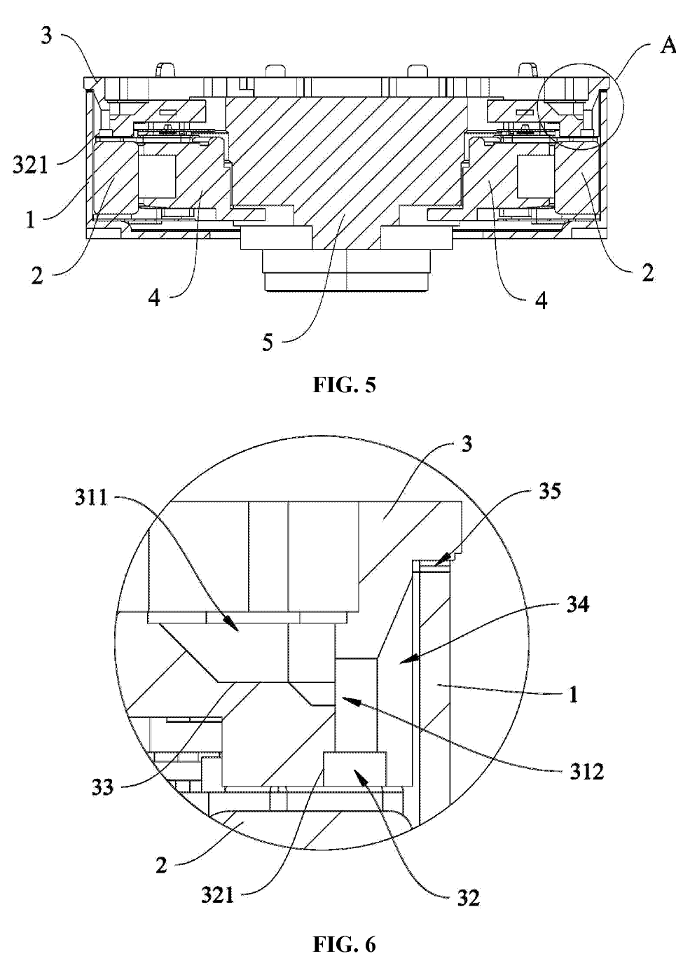

As shown in FIGS. 5 to 10, the opening size of the guide groove 34 is gradually increased from a side of the guide groove 34 facing away from the inner wall of the shielding cover 1 to a side of the guide groove 34 facing the inner wall of the shielding cover 1. As the opening size of the guide groove 34 is gradually increased, the adhesive can flow more smoothly toward the inner wall of the shielding cover 1 and achieve a large area coverage, which is conducive to improving the dispensing effect between the base 3 and the shielding cover 1.

In one or more embodiments, the adhesive overflow groove 32 is provided with a diameter expanded portion 321, and an outlet end of the adhesive overflow groove 32 is disposed at the diameter expanded portion 321. When the adhesive passes through the diameter expanded portion 321, since the opening size of the diameter expanded portion 321 is increased, the flow direction of the adhesive is adjusted and dispersed to a certain extent, which helps the adhesive to diffuse more uniformly between the base 3 and the magnet assembly 2, thereby improving the dispensing effect.

As shown in FIGS. 1 to 12, an adhesive pouring groove 36 is disposed on a peripheral wall of the base 3, an outlet end of the adhesive pouring groove 36 faces the inner wall of the shielding cover 1, and the adhesive pouring groove 36 and the inner wall of the shielding cover 1 enclose to form an adhesive pouring channel 361, thereby ensuring that the adhesive can diffuse along an extension direction of the adhesive pouring channel 361 and ensuring a firm connection between the base 3 and the shielding cover 1.

Moreover, a step portion 362 is disposed in the adhesive pouring groove 36 and is arranged at an angle with an extension direction of the adhesive pouring groove 36. The step portion 362 is disposed so that the flow speed of the adhesive is gradually slowed down in a flow process. Not only can bubbles generated by the adhesive in the flow process be decreased so that the dispensing effect is improved, but a contact area between the adhesive and the base 3 can also be increased, which is conducive to improving the connection strength.

Moreover, a guide portion 363 is further disposed in the adhesive pouring groove 36 and gradually approaches the inner wall of the shielding cover 1 in a direction toward the magnet assembly 2, thereby ensuring that the adhesive can gradually approach the magnet assembly 2 along the guide portion 363 in the flow process and improving the accuracy and uniformity of the filling.

In one or more embodiments, multiple adhesive pouring grooves 36 are disposed at intervals along the circumferential direction of the base 3, thereby increasing the contact area between the adhesive and other components and improving the connection strength between the base 3 and the shielding cover 1.

As shown in FIGS. 1 to 4, a first avoidance port 37 is disposed on the base 3, and a second avoidance port 13 is disposed on the shielding cover 1. The first avoidance port 37 and the second avoidance port 13 are disposed to facilitate providing sufficient space for the lens 5, thereby ensuring that the lens 5 can be normally mounted and the focal length of the lens 5 can be adjusted. The movable assembly 4 includes a movable frame 41 and a coil assembly 42 wound around the movable frame 41, a third avoidance port 411 is disposed on the movable frame 41, and the magnet assembly 2 is disposed around the coil assembly 42 to ensure a normal use of the camera module. A front end of the lens 5 passes through the third avoidance port 411 and the second avoidance port 13 in sequence, and a rear end of the lens 5 is exposed from the first avoidance port 37, thereby ensuring the compactness and reliability of the overall structure of the camera module. The magnet assembly 2 includes multiple magnet blocks disposed at intervals around the coil assembly 42. Through an interaction between the multiple magnet blocks and the coil assembly 42, the moving direction and distance of the lens 5 can be accurately controlled, thereby achieving functions such as automatic focus and optical image stabilization.

In one or more embodiments, an assembly port 12 is disposed on the shielding cover 1, the assembly port 12 and the second avoidance port 13 are oppositely disposed at two ends of the shielding cover 1 respectively, and the base 3 is connected to the assembly port 12 to facilitate the mutual assembly of the base 3, the lens 5, the movable assembly 4, the magnet assembly 2 and the shielding cover 1, thereby improving the compactness of the overall structure of the camera module.

As shown in FIGS. 1 to 12, the base 3, the magnet assembly 2 and the shielding cover 1 are adhered by pouring the adhesive into the adhesive injection channels 31 with the help of the adhesive overflow grooves 32, the guide grooves 34 and the capillary channel 35, thereby avoiding an additional dispensing operation on the magnet assembly 2 and reducing the number of times of dispensing. Moreover, the adhesive does not flow onto the movable assembly 4 and the lens 5, thereby improving the dispensing effect and the operation efficiency.

It is to be noted that the adhesive used in the present embodiment includes, but is not limited to, epoxy resin, UV glue, and epoxy resin adhesive (AB adhesive). As long as the dispensing effect between the base 3, the magnet assembly 2 and the shielding cover 1 can be ensured, a specific material of the adhesive is not limited herein.

Apparently, the preceding embodiments of the present disclosure are only illustrative examples of the present disclosure and are not intended to limit embodiments of the present disclosure. Those of ordinary skill in the art can make various apparent modifications, adaptations, and substitutions without departing from the scope of the present disclosure. All embodiments do not need to be and cannot be exhausted herein. Any modifications, equivalent substitutions, and improvements made within the spirit and principle of the present disclosure fall within the scope of the claims of the present disclosure.

What is claimed is:

1. An adhesive injection structure of a camera module, wherein the camera module comprises a base, a magnet assembly fixed on the base, a movable assembly movably disposed on the base, a lens mounted on the movable assembly, and a shielding cover covering the base, and both the magnet assembly and the movable assembly are located in a mounting cavity of the shielding cover; and
the adhesive injection structure comprises:
a plurality of adhesive injection channels arranged at intervals along a circumferential direction of the base, wherein adhesive injection ports of the plurality of adhesive injection channels are located at an end of the base facing away from the magnet assembly, and adhesive outlets of the plurality of adhesive injection channels face an inner wall of the shielding cover;
a plurality of guide grooves disposed at intervals on an outer periphery of the base and connected to the adhesive outlets in one-to-one correspondence, wherein outlet ends of the plurality of guide grooves face the inner wall of the shielding cover;
a capillary channel disposed between the shielding cover and the base and connected to each of the plurality of guide grooves; and
a plurality of adhesive overflow grooves disposed at intervals on the outer periphery of the base and connected to the adhesive outlets in one-to-one correspondence, wherein outlet ends of the plurality of adhesive overflow grooves face the magnet assembly.

2. The adhesive injection structure of the camera module according to claim 1, wherein a buffer step is disposed in an adhesive injection channel of the plurality of adhesive injection channels, and the buffer step is arranged at an angle with an extension direction of the adhesive injection channel.

3. The adhesive injection structure of the camera module according to claim 2, wherein a plurality of buffer steps are provided and disposed at intervals along the extension direction of the adhesive injection channel, and areas of the plurality of buffer steps are decreased in sequence along a direction from an adhesive injection port of the adhesive injection channel to an adhesive outlet of the adhesive injection channel.

4. The adhesive injection structure of the camera module according to claim 1, wherein an opening size of a guide groove of the plurality of guide grooves is gradually increased from a side of the guide groove facing away from the inner wall of the shielding cover to a side of the guide groove facing the inner wall of the shielding cover.

5. The adhesive injection structure of the camera module according to claim 1, wherein a diameter expanded portion is disposed in an adhesive overflow groove of the plurality of adhesive overflow grooves, and an outlet end of the adhesive overflow groove is disposed at the diameter expanded portion.

6. The adhesive injection structure of the camera module according to claim 1, wherein an adhesive pouring groove is disposed on a peripheral wall of the base, an outlet end of the adhesive pouring groove faces the inner wall of the shielding cover, and the adhesive pouring groove and the inner wall of the shielding cover enclose to form an adhesive pouring channel.

7. The adhesive injection structure of the camera module according to claim 2, wherein an adhesive pouring groove is disposed on a peripheral wall of the base, an outlet end of the adhesive pouring groove faces the inner wall of the shielding cover, and the adhesive pouring groove and the inner wall of the shielding cover enclose to form an adhesive pouring channel.

8. The adhesive injection structure of the camera module according to claim 3, wherein an adhesive pouring groove is disposed on a peripheral wall of the base, an outlet end of the adhesive pouring groove faces the inner wall of the shielding cover, and the adhesive pouring groove and the inner wall of the shielding cover enclose to form an adhesive pouring channel.

9. The adhesive injection structure of the camera module according to claim 4, wherein an adhesive pouring groove is disposed on a peripheral wall of the base, an outlet end of the adhesive pouring groove faces the inner wall of the shielding cover, and the adhesive pouring groove and the inner wall of the shielding cover enclose to form an adhesive pouring channel.

10. The adhesive injection structure of the camera module according to claim 5, wherein an adhesive pouring groove is disposed on a peripheral wall of the base, an outlet end of the adhesive pouring groove faces the inner wall of the shielding cover, and the adhesive pouring groove and the inner wall of the shielding cover enclose to form an adhesive pouring channel.

11. The adhesive injection structure of the camera module according to claim 6, wherein a step portion is disposed in the adhesive pouring groove and arranged at an angle with an extension direction of the adhesive pouring groove.

12. The adhesive injection structure of the camera module according to claim 11, wherein a guide portion is disposed in the adhesive pouring groove and gradually approaches the inner wall of the shielding cover in a direction toward the magnet assembly.

13. The adhesive injection structure of the camera module according to claim 6, wherein a plurality of adhesive pouring grooves are provided and disposed at intervals along the circumferential direction of the base.

14. The adhesive injection structure of the camera module according to claim 1, wherein a first avoidance port is disposed on the base, and a second avoidance port is disposed on the shielding cover; the movable assembly comprises a movable frame and a coil assembly wound around the movable frame, wherein a third avoidance port is disposed on the movable frame, and the magnet assembly is disposed around the coil assembly; a front end of the lens passes through the third avoidance port and the second avoidance port in sequence, and a rear end of the lens is exposed from the first avoidance port.

15. The adhesive injection structure of the camera module according to claim 14, wherein an assembly port is disposed on the shielding cover, the assembly port and the second avoidance port are oppositely disposed at two ends of the shielding cover respectively, and the base is connected to the assembly port.

16. The adhesive injection structure of the camera module according to claim 14, wherein the magnet assembly is disposed around the coil assembly.

17. The adhesive injection structure of the camera module according to claim 16, wherein the magnet assembly comprises a plurality of magnet blocks disposed at intervals around the coil assembly.

18. The adhesive injection structure of the camera module according to claim 7, wherein a step portion is disposed in the adhesive pouring groove and arranged at an angle with an extension direction of the adhesive pouring groove.

19. The adhesive injection structure of the camera module according to claim 18, wherein a guide portion is disposed in the adhesive pouring groove and gradually approaches the inner wall of the shielding cover in a direction toward the magnet assembly.

20. The adhesive injection structure of the camera module according to claim 7, wherein a plurality of adhesive pouring grooves are provided and disposed at intervals along the circumferential direction of the base.
